(19) United States
(12) Patent Application Publication
(10) Pub. No.: US 2008/0018488 A1
(43) Pub. Date: Jan. 24, 2008

(54) Enhanced gauge tracking system

(75) Inventors: Ronald Struck, Flusing, MI (US); Christopher J. Volpe, Waterford, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/488,948

(22) Filed: Jul. 19, 2006

(51) Int. Cl. G08B 5/24; B60Q 1/00

(52) U.S. Cl. 340/815.86; 340/441

(57) ABSTRACT

A gauge assembly includes a dial face with a plurality of markings for conveying information regarding a vehicle operating parameter, such as vehicle speed, or engine RPM. A plurality of light emitting diodes (LED) are selectively illuminated to track the position of the pointer about the dial face to provide an additional indication of a measurement communicated to an operator.

### BACKGROUND OF THE INVENTION

This invention generally relates to a gauge for communicating information to a vehicle operator. More particularly, this invention relates to a gauge including features for visually enhancing a position of a pointer on the gauge.

Information indicative of vehicle operating performance and operations are communicated to an operator by gauges, dials or other instrumentation. A dial including graduations about a circular path of a rotating pointer is common for conveying information indicative of vehicle speed, engine rpm and many other operating parameters. As the dial is such a common recognized and accepted instrument, it is often desired to maintain this configuration in newer vehicles. It is also desired to generate interest in new vehicle models. Accordingly, different layouts and dial configurations are continuously being introduced and implemented.

Accordingly, it is desirable to design and develop a dial gauge assembly with pleasing aesthetic features that maintain recognized readability features while providing the desired updated appearance.

### SUMMARY OF THE INVENTION

An example gauge assembly includes a dial face with a plurality of markings for conveying information regarding a vehicle operating parameter, such as vehicle speed, or engine RPM. A plurality of light emitting diodes (LED) are selectively illuminated to track the position of the pointer about the dial face.

The pointer is rotated about the dial face relative to markings to communicate the status of the current operating parameter. Illumination is controlled such that a selected number of LEDs are illuminated that track movement of the pointer and provide an additional indication of a measurement communicated to an operator. As the pointer sweeps about the dial face, more LEDs are illuminated to highlight the position of the pointer, and the measurement communicated by the gauge assembly.

Accordingly, the example gauge assemblies illustrated and described combine selective lighting to illustrate a measured value to enhance the visual appearance provided by the sweeping rotation of the pointer.

These and other features of the present invention can be best understood from the following specification and drawings, the following of which is a brief description.

### BRIEF DESCRIPTION OF THE DRAWINGS

FIG. 1 is a schematic view of an example gauge assembly.

FIG. 2 is a perspective view of an example circuit board including a plurality of light sources.

FIG. 3 is an enlarged view of a few example light sources proximate an example pointer.

FIG. 4 is a schematic view of another example gauge assembly.

### DETAILED DESCRIPTION OF THE PREFERRED EMBODIMENT

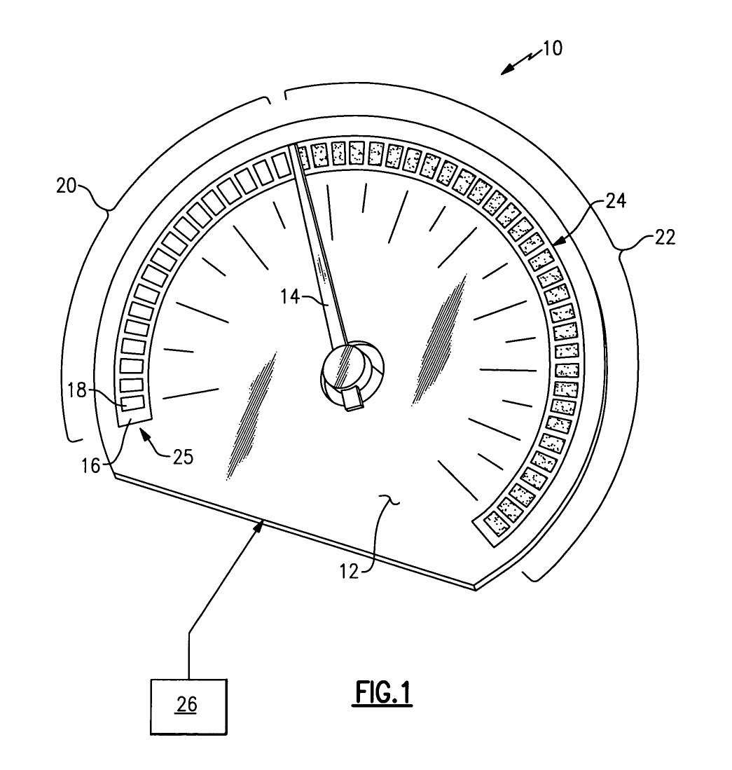

Referring to FIG. 1, a gauge assembly 10 includes a dial face 12 with a plurality of markings for conveying information regarding a vehicle operating parameter, such as vehicle speed, or engine RPM. A pointer 14 is rotated about the dial face 12 relative to the markings to communicate the status of the current operating parameter. A controller 26 receives information form various sensors or other devices that measure desired operating parameters and changes that information into corresponding rotational movement of the pointer 14.

The example gauge assembly 10 includes a plurality of light emitting diodes (LED) 25 that define a circular path 24 proximate a perimeter of the dial face 12. The LEDs 25 are selectively illuminated to track the position of the pointer 14 about the dial face 12. The controller 26 controls illumination of the LEDs 25 such that a selected number of LEDs 25 are illuminated as indicated at 20 that track movement of the pointer 14 and provide an additional indication of a measurement communicated to an operator.

As the pointer 14 sweeps about the dial face 12, more LEDs are illuminated to highlight the position of the pointer 14, and the measurement communicated by the gauge assembly 10. The illuminated LEDs 20 are illustrated as white in contrast with the darkened non-illuminated LEDs indicated at 22.

The dial face 12 includes a mask 16 that defines a plurality of openings 18. The openings provide a defined outline for the light emitted by the underlying LEDs 20. The openings 18 in the mask 16 block a portion of light and also provide a division of light through the dial face 12 to provide the desired lighted increments.

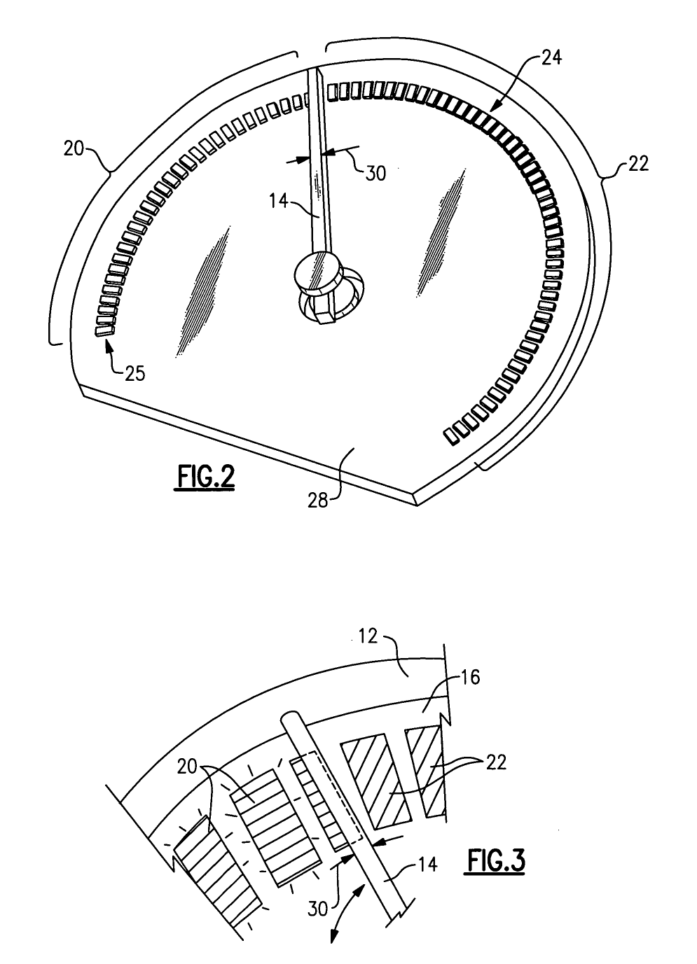

Referring to FIG. 2, the LEDs 25 are mounted to a circuit board 28 in the desired circular orientation to define and correspond with the sweeping rotation of the pointer 14. The plurality of LEDs 25 are arranged such that each LED is less than a width 30 of the pointer 14. The spacing between the LEDs 25 is such that illumination is not affected in advance of the sweep of the pointer 14. This provides for a visible division from the illuminated LEDs 20 and the non-illuminated LEDs 22. The controller 26 selectively illuminates the LEDs 20 such that a lighted LED is always disposed under the pointer 14 during the sweeping rotary motion.

Referring to FIG. 3, an enlarged view of a portion of the dial face 12 is shown that includes the pointer 14 disposed over the last illuminated LED 20 to provide the desired boarder and visible division between lighted and non-illuminated LEDs. The width 30 of the pointer 14 is defined to always cover a portion of an illuminated LED 20 to provide the desired division.

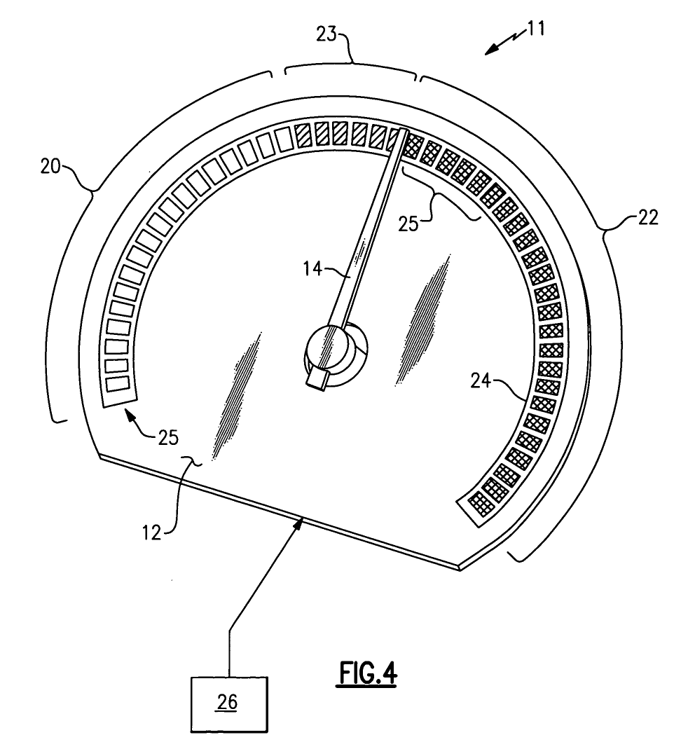

Referring to FIG. 4 another gauge assembly 11 is illustrated with the pointer 14 swept around the dial face 12. The first illuminated LEDs 20 are illuminated and emit a light of a first color that in this example is white. A second group of illuminated LEDs 23 emits a second color that is different than the first, for example green to further enhance that aesthetic appearance of the gauge assembly 10. A third group of lights 25 includes another color different from the first and second colors to further provide distinction between ranges of the gauge assembly 11. The example third group of lights 25 are yellow. Further, the example non-illuminated group 22 remains unlit and can include LEDs that emit other colors such as red to further highlight desired ranges measured by the gauge assembly 11.

Accordingly, the example gauge assemblies illustrated and described combine selective lighting to illustrate a measured value to enhance the visual appearance provided by the sweeping rotation of the pointer 14.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A dial gauge assembly comprising:
a gauge face including markings indicative of an operating parameter;
a pointer movable relative to the gauge face; and
a plurality of light sources selectively illuminated responsive to a position of the pointer relative to the gauge face.

2. The assembly as recited in claim 1, wherein the plurality of light sources are disposed along a radial path of the pointer.

3. The assembly as recited in claim 1, wherein the plurality of light sources are mounted to a printed circuit board covered by the gauge face.

4. The assembly as recited in claim 3, wherein the gauge face includes a plurality of openings corresponding to the radial path of the pointer.

5. The assembly as recited in claim 4, wherein the plurality of lights illuminate to represent the radial path from an initial position of the pointer to a current position of the pointer spaced apart from the initial position.

6. The assembly as recited in claim 4, plurality of light sources comprise light sources of at least two different colors.

7. The assembly as recited in claim 4, wherein the gauge face comprises a graduated segment filter.

8. The assembly as recited in claim 1, wherein the pointer at least partially covers the plurality of light sources and includes a shroud on a portion of the pointer covering the plurality of light sources to prevent light from bleeding past the pointer.

9. The assembly as recited in claim 1, wherein the dial gauge assembly comprises a speedometer and the markings are indicative of a speed of a vehicle.

10. The assembly as recited in claim 1, wherein the dial gauge assembly comprises a tachometer and the marking are indicative of engine speed.

11. A dial gauge assembly comprising:
a gauge face including a plurality of openings arranged radially;
a pointer rotatable relative to the gauge face; and
a plurality of light sources arranged radially for communicating light through the plurality of openings responsive to rotation of the pointer.

12. The assembly as recited in claim 11, wherein the pointer begins at an initial point and rotates about the gauge face to a current position, and the plurality of light sources are selectively illuminated from the initial position to the current position of the pointer.

13. The assembly as recited in claim 11, wherein the plurality of light source are mounted to a circuit board disposed on a side of the gauge face opposite the pointer.

14. The assembly as recited in claim 11, wherein the pointer includes a blocking portion disposed over one of the plurality of light sources for blocking a portion of light from being emitted past the pointer.

15. The assembly as recited in claim 11, wherein the plurality of light sources comprise a plurality of light emitting diodes.

16. The assembly as recited in claim 11, wherein the plurality of light sources comprises light sources of at least two different colors.

17. The assembly as recited in claim 11, wherein a plurality of light sources are illuminated responsive to the pointer passing over a position of each of the plurality of light sources.
